(19) United States
(12) Patent Application Publication
(10) Pub. No.: US 2007/0027925 A1
(43) Pub. Date: Feb. 1, 2007

(54) System and method for public geospatial registrar and services

(76) Inventors: William Spencer, Ellicott City, MD (US); Todd Marks, Oella, MD (US)

Correspondence Address: PILLSBURY WINTHROP SHAW PITTMAN, LLP, P.O. BOX 10500, MCLEAN, VA, 22102, US

(21) Appl. No.: 11/492,999

(22) Filed: Jul. 26, 2006

Related U.S. Application Data
(60) Provisional application No. 60/702,658, filed on Jul. 27, 2005.

(51) Int. Cl. G06F 17/00

(52) U.S. Cl. 707/104.1

(57) ABSTRACT

The system of the invention includes a registrar that receives at least one defined geospatial location and a data set of information from a registrant. The system also includes a central registration database that stores the at least one defined geospatial location and the data set. The at least one defined geospatial location is then associated with the data set in the central registration database. A client module residing on an end-user device then sends position information regarding an end-user to the registrar. If it is determined that the end-user position information defines a position that is within the at least one defined geospatial location part or all of the associated data set is sent to the end-user device for presentation to the end-user.

### REFERENCE TO RELATED APPLICATIONS

This application claims priority to U.S. Provisional Patent Application No. 60/702,658, filed Jul. 27, 2005, which is hereby incorporated by reference herein in its entirety.

### FIELD OF THE INVENTION

The invention relates generally to a computer-implemented system and method for registering a location with a registrar, associating information with a registered location, and providing the associated information to one or more end-users.

### BACKGROUND OF THE INVENTION

Typically, information related to locations on the planet is accessible only with foreknowledge of one or more characteristics of the location. For example, if a person desires information regarding a restaurant, that person must know the name, address or other information regarding the restaurant to access the information. As such, there is a need to more readily obtain desired information regarding a location.

Information regarding locations on the planet is accessible via various sources such as, for example, phone directories and, more recently, the Internet. However, the information found on these resources is typically associated with the characteristics mentioned above. As such there is a need for systems and methods for registering information related to a location to the location itself.

### SUMMARY OF THE INVENTION

In one general aspect, the invention provides a registrar for registering a geospatial location to information. In various embodiments, a geospatial location may be defined by a single position, a line (as defined by two or more positions), an area (as defined by three or more positions), or a volume (as defined by four or more non-coplanar positions). In some embodiments, a “position” may comprise a point on the planet that can be defined by any measurement system (current or future) such as, for example, a measurement system that utilizes latitude, longitude, and elevation. The information that may be registered to a geospatial location may include a URL, an IP address, one or more files, or other information. The registered information may be provided to an end-user via end-user devices based upon an actual position of the end-user, a position of interest to the end-user, or other position associated with the end-user.

In another general aspect, the invention provides a system for registering a geospatial location with a registrar, associating a set of information with the registered location, and providing the information to end-users via end-user devices. In one embodiment, the system may include a registrar, one or more interfaces, one or more databases, a client module, and/or other elements. The system may interact with registrants, end-users, and or other entities, via a data communications network.

The registrar may include a computer-implemented system for maintaining a relationship between geospatial locations and information. For example, the computer-implemented system of the registrar may include one or more servers, desktop computers, laptop computers or other devices that provide storage, processing, and/or other features to the system of the invention.

In yet another general aspect, the invention provides one or more processes for registering a geospatial location with the registrar, associating a set of information with a registered location, and providing the associated information to one or more end-users via end-user devices. In one embodiment, a process according to the invention may include a registrant accessing the registrar via a computing device associated with the registrant and a registration interface provided by the registrar. An account may then be created with the registrar for the registrant.

The registrant may then define a geospatial location that the registrant wishes to register with the registrar. In one embodiment, the registrant may provide latitudinal, longitudinal, and/or elevation coordinates, GPS coordinates, or other coordinate data that specifies the one or more positions defining the geospatial location the registrant wishes to register. Other methods of defining a geospatial location may be used.

Once the registrant has defined the geospatial location he or she wishes to register, the registrar then searches its associated databases to ensure that the defined geospatial location does not conflict with other registrations. In some embodiments, a single location may be registered more than once, provided that multiple registrations for a single location (or for a location that overlaps a previously registered location) are not allowed for the same purpose or for otherwise conflicting purposes.

In some embodiments, if no conflicts are found (or after any conflicts are resolved) a fee for registering the defined location(s) may then be calculated and charged to the registrant. In one embodiment, the amount charged to registrant for registering a defined location may be based on one or more factors such as, for example, a function of the total area or volume of the defined geospatial location, a function of the population in or around the defined geospatial location, a function of the amount or category of information registrant is registering to the defined geospatial location, a function of the amount or type of services provided in association with the defined geospatial location, a function of the length of time the registrant wishes to register the defined geospatial location, and/or other factors.

After any fee has been charged, the registrant may manage his or her registered locations using his or her account with registrar. Managing a registered location may include associating a set of information with a registered location. To manage one or more registered locations the registrant first logs on to their account and selects one or more of his or her geospatial locations to manage. The registrant then enters information (i.e., a “data set”) to be associated with the selected geospatial locations.

In one embodiment, the information to be associated with the selected locations may include textual information (e.g., text files), one or more media files (e.g., audio, video), other types of files containing data. In one embodiment the information to be associated with a registered location may include one or more URLs, IP addresses, or other information.

The information to be associated with a registered location may be entered by simply typing the information into a prompt provided by the registrar. For example, if the information to be registered with the location were a URL or IP address, the URL or IP address could be typed into a prompt of a graphical user interface provided by the registrar. In other embodiments, an interface provided by the registrar may enable the registrant to transmit any text, media, or other files to the registrar by “browsing” a local drive or by otherwise specifying a path to the one or more files on the registrant's computing system and uploading the files to the registrar. The set of information entered by the registrant may then be associated/registered with selected registered locations and saved in the database of the registrar.

The registrar may be accessed via one or more triggering events. Each triggering event may be associated with an “end-user position” that is used to determine which information registered with the registrar is provided to an end-user. There may be multiple types of end-user positions. For example, one type of end-user position may include the “actual position” of the end-user. In these embodiments, the current or actual position of the end-user (e.g., as determined by a GPS enabled end-user device) is considered the “end-user position” and is associated with the triggering event. An example of a triggering event wherein the actual position of the end-user is used as an end-user position may include an instance wherein an end-user and his or her corresponding end-user device enter or come within a specified distance of a geospatial location registered with the registrar. Approaching or entering the registered location triggers the client module residing on the end-user device to access the registrar.

Another type of end-user position data may include a “position of interest.” In these embodiments, the actual position of the end-user or the end-user device is not considered the end-user position and is not associated with the triggering event. In these embodiments, a position that the end-user has explicitly or implicitly indicated an interest in is considered the “end-user position” and is associated with the triggering event. Examples of a triggering event wherein a position of interest is considered an end-user position may include an end-user typing the name of a place located within a registered location into a search engine (explicit indication of interest) or visiting a website of an event held at a place within a registered geospatial location (implicit indication of interest). The client module residing on the end-user device transmits these explicit or implicit indications of interest to the registrar, which triggers access to information stored on the registrar.

Triggering events may also be based on the fulfillment of certain conditions. For example, the end-user may specify one or more preferences as to when to receive information (i.e., part or all of a data set) associated with a registered location. These preferences may define one or more conditions that must be met for the end-user to receive associated information.

After the triggering event has occurred, a client module residing on end-user device connects the end-user device to the registrar via the network (e.g., the internet, a wireless network, a combination thereof, or other network). The end-user position associated with the triggering event is then communicated to the registrar. The registrar then finds the registered geospatial location corresponding to the end-user position and grants the client module access to the information associated with registered geospatial location that is stored in the database of the registrar. The accessed information is then communicated to the end-user via the end-user device.

In one embodiment, the end-user device may maintain a persistent connection to the registrar (e.g., similar to a wireless email device's connection to a wireless email server). In one embodiment, the end-user device may continuously send end-user position data to the registrar. In another embodiment, the end-user device may send end-user position data to the registrar periodically or at a predetermined interval. In one embodiment, when the end-user position sent to the registrar is within a location registered with the registrar, the registrar may send (or the end-user device may retrieve) part or all of the information associated with the registered location to the end-user device. In one embodiment, when the end-user position sent to the registrar is within a location registered with the registrar, the information associated with the location is only sent to the end-user device if the end-user's preferences allow the information to be sent. As such, the end-user's preferences act as a filter for information the end-user receives from the registrar. For example, an end-user may approach a gas station owned by Company X, which is registered with the registrar. However, the end-user's preferences may specify the end-user only wishes to receive information related to gas-stations owned by Company Y. As such, the information associated with the registered location (the gas station owned by company X) is not sent to the end-user device.

In embodiments where a persistent or near-persistent connection is maintained between an end-user device and the registrar, the triggering event may be considered an instance wherein the end-user device sends an end-user position to the registrar that is within a location registered with the registrar. As the end-user device is already connected to the registrar, the information associated with the registered location is sent to the end-user device automatically (absent any preferences to the contrary). Other events that initiate or are part of a causal chain of events leading to transmission of information associated with a registered location from the registrar to an end-user device may also be considered triggering events.

In another general aspect, the invention registers geospatial locations (rather than URL's) to IP addresses. When the position of an end-user device (e.g., as tracked by a GPS-enabled system) comes within or approaches a registered geospatial location, the client module residing on the end-user device communicates its position to the registrar. The registrar finds the registered location corresponding to the transmitted position, and translates the location to its registered IP address. The IP address is then sent to the end-user device. The IP address is used by the end-user device to access a website or other internet resource that is associated with the IP address.

These and other objects, features, and advantages of the invention will be apparent through the detailed description, the drawings, and the claims attached hereto. It is also to be understood that both the foregoing summary and the following detailed description are exemplary and not restrictive of the scope of the invention.

### BRIEF DESCRIPTION OF THE DRAWINGS

FIG. 1A illustrates an example of a system for registering geospatial locations with a registrar, associating geospatial locations with information, and providing the associated information to end-users, according to various embodiments of the invention.

FIG. 1B illustrates an example of information flow among entities, according to various embodiments of the invention.

FIG. 1C illustrates an example of information flow among entities, according to various embodiments of the invention.

FIG. 2 illustrates an example of a process for registering geospatial with a registrar, according to various embodiments of the invention.

FIG. 3 illustrates a process for managing registered geospatial locations, according to various embodiments of the invention.

FIG. 4 illustrates a process for providing information associated with a registered geospatial location to an end-user, according to various embodiments of the invention.

### DETAILED DESCRIPTION

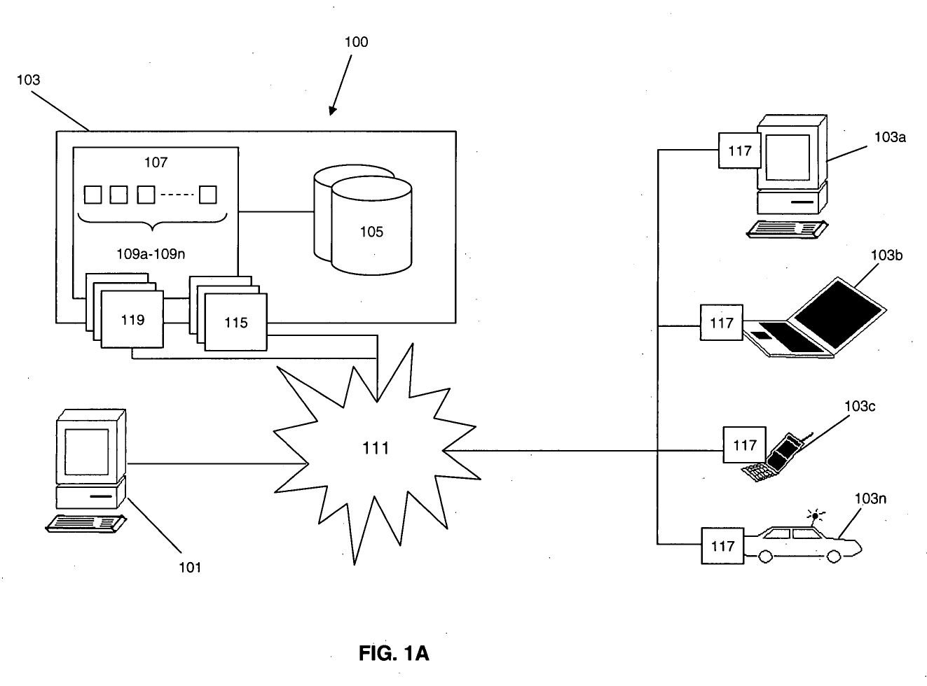

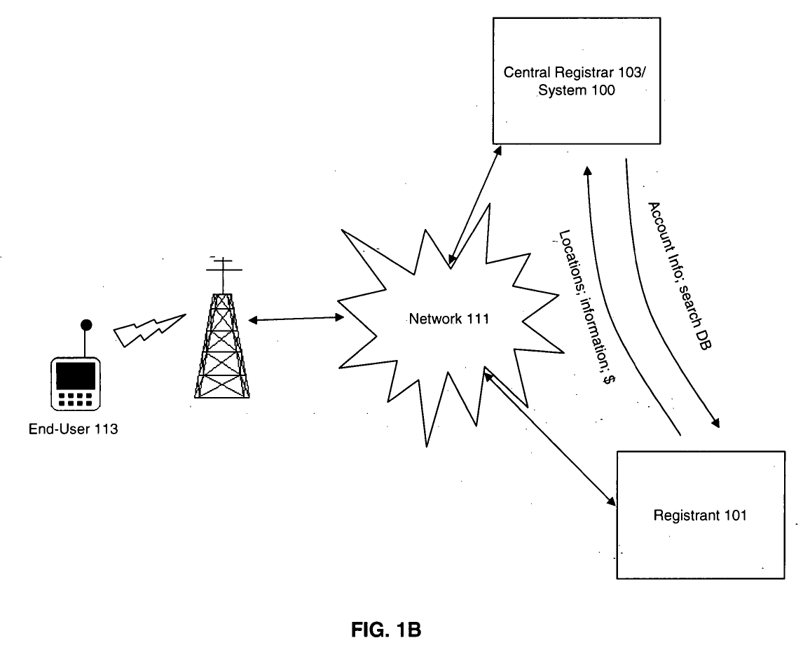

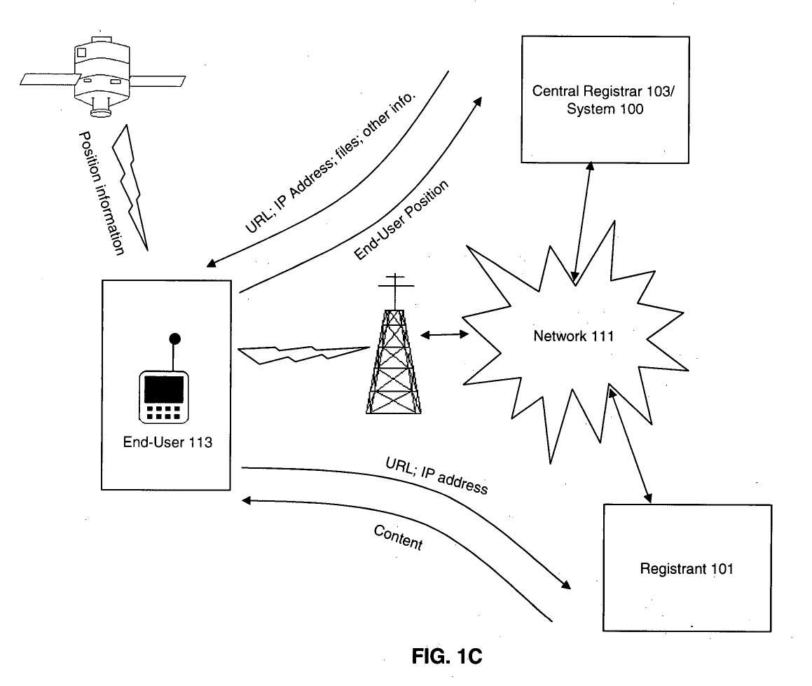

A “geospatial location” or “location,” as referred to herein, may comprise a single position, a line (as defined by two or more positions), an area (as defined by three or more positions), or a volume (as defined by four or more positions). In various embodiments, a “position” may comprise a point on the planet that can be defined by any measurement or coordinate system (current or future) such as, for example, a measurement system that utilizes and x, y, and/or z coordinates, latitude, longitude, and elevation, geocodes, and/or other measurement system. FIG. 1A illustrates a system 100 for registering one or more geospatial locations with a registrar, associating information with one or more registered locations, and providing associated information to end-users via end-user devices. System 100 may include, a registrar 103, one or more data systems or databases 105, a control application 107, one or more modules 109a-109n, one or more user interfaces 115, one or more data communication interfaces 119, and/or other elements. System 100 may interact with registrants 101, end-users 113a-113n, and or other entities, via a data communications network 111.

In one embodiment, registrant 101 may include an entity that desires to register a location and associate information with the location, to provide the associated information to end-users 113, to provide services related to the registered location and/or its associated information and/or to otherwise utilize a registration between a location and information. For example, registrant 101 may include one or more business organizations, trade associations, not-for-profit organizations,- educational organizations, religious organizations, community organizations, government organizations, individuals, or any other entity that desires to register a location to information.

Registrar 103 may include a computer-implemented system for maintaining a relationship between geospatial locations and information. For example, the computer-implemented system of registrar 103 may include one or more special purpose or general purpose computers and/or processors capable of responding to and executing instructions in a defined manner such as, for example, servers, desktop computers, work stations, mainframe computers, laptop computers or a combination of two or more of these devices or other devices that provide or facilitate storage, processing, and/or data communication features to system 100.

Registrar 103 may also include one or more databases 105 that store account information regarding registrants 101, store identifying/defining information regarding geospatial locations, store information and/or content associated with registered geospatial locations, store metrics collected from interactions between registrants 101/end-user 113 and registrar 103, and/or store other information. The information and/or data may be embodied permanently or temporarily in any type of machine, component, physical or virtual equipment, storage medium, or propagated signal wave. In particular, data enabling the features and functions of the invention (including data stored by databases 105, data comprising control application 107, data comprising modules 109a-109n, and other data) may be stored on a storage device or medium such as, for example, a memory, including volatile and non-volatile memory (e.g., a read-only memory [ROM], a random access memory [RAM], a flash memory, a floppy disk, a hard disk, a tape, a DROM, a flop-flop, a register, an SRAM, DRAM, PROM, EPROM, OPTROM, NOVRAM, RAMBUS, or other memory), such that if the storage medium or device is accessed, the specific data is provided and/or the steps, operations, processes, and/or instructions are performed. One or more data systems 105 may also maintain relationships (e.g., mappings/associations) between the registered geospatial locations and their associated information and/or may perform other storage, mapping, or other functions. Database 105 may include a schema that is designed to maintain relationships/associations between geospatial locations and specific information related to each geospatial location. Database 105 may include any combination of databases or other data storage devices. Registrar 103 may also include other databases.

Registrar 103 may include any number of software applications, including, for example, control application 107, to enable the features and functions of the invention. The software applications may include a computer program, a piece of code, an instruction, or some combination thereof, for independently or collectively instructing registrar 103 and its associated processing devices to operate as desired. The processing devices comprising registrar 103 may access, store, manipulate, and create data which may be accessed from or stored in a storage device in response to the software applications of the invention.

Control application 107 may implement an interface such as, for example, a host or server application for presenting an Internet web site, an intranet site, or other host or computer application. Control application 107 may be maintained by an administrator, service provider, or other entity. Control application 107 may also include one or more software modules 109a-109n that enable account setup for registrants 101; selection, definition, and/or registration of one or more geospatial locations; association of information with one or more geospatial locations; calculation of fees for registration of geospatial locations and/or other fees associated with the invention; determining availability of geospatial locations for registration; querying of registered locations and information; uploading information to be associated to a registered geospatial location; receiving communication from an end-user device or module resident thereon; providing information related to registered geospatial locations to end-user devices or modules resident thereupon; and/or for enabling other features and functions of the invention. One or more of modules 109a-109n of control application 107 may be combined and/or omitted as desired or necessary to implement the various features, elements, and implementations of the invention.

In one embodiment, system 100 may communicate with registrants 101, end users 113, or other entities via a network 111. Network 111 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular telephone network, or other communications network. Any suitable communications link may be utilized to link the elements of system 100 to network 111. The communications links may be configured to send and receive signals (e.g., electrical, electromagnetic, optical, or other signal) that convey or carry signals representing various types of analog and/or digital data and information. For example, the communications links used in the invention may include any one or more of a copper telephone line, a fiber optic cable, a Digital Subscriber Line (DSL) connection, a Digital Data Service (DDS) connection, an Ethernet connection, an Integrated Services Digital Network.(ISDN) line, a synchronous optical network (SONNET) connection, an analog modem connection, a cable modem connection, or other connection. In addition, the communications paths may comprise one or more wireless links that transmit and receive electromagnetic signals such as, for example, radio signals, infrared signals, microwave signals, or other signals, to convey information and data.

In one embodiment, one or more end-users 113a-113n may interact with system 100. An end-user 113 may include any entity such as, for example, a person or group of people, a business, an organization, an association, or other entity to which access to information related to one or more geospatial locations is provided and/or to which services related to the one or more geospatial locations is provided. FIG. 1A represents end-users 113a-113n as the end-user devices that they may utilize to access and/or receive information or services related to a geospatial location registered with registrar 103 or to otherwise interact with registrar 103. In one embodiment, an end-user device may include any computing device that can collect and/or provide end-user position information to registrar 103. For example, an end-user device may comprise a processor a microcomputer, a desktop computer, a laptop computer, a cellular/mobile/satellite phone, a personal digital assistant (PDA), an wireless e-mail device (e.g., a Blackberry™), a personal navigation system (e.g., GPS enabled), an vehicle, aircraft, or nautical navigation system (e.g., GPS enabled), a golf cart or golf course navigation system, or other computing device or combination thereof that can collect and/or provide end-user position information to registrar 103 and that enables access to and/or receipt of information from registrar 103 via network 111. In some embodiments, an end-user device may include a computing device whose geospatial location can be determined (for example, a global positioning system [GPS] tracked device, a wireless mobile device that is trackable on a wireless network/cellular network, or some other combination of technologies that are able to determine a position of the device).

In some embodiments, the end-user devices may have one or more modules such as, for example, client module 117, installed thereupon. Client module 117 may include a software module that resides on an end-user device and facilitates communication with a network 111 (e.g., the Internet) and/or with registrar 103. Client module 1 17 also facilitates the communication or delivery of information, content and/or, services associated with a registered geospatial location to an end user 113 by sending and receiving data between an end-user device and registrar 103, registrant 101, and/or other entities. Client module 117 may also perform other features or functions. In one embodiment, client module 117 may implement a browser or a micro-browser to facilitate communication between an end-user 113 and registrar 103, registrant 101, and/or other entities.

While the description of the invention herein generally refers to transmission of information from registrant 101 to end-user 113 through registrar 103, in some embodiments, certain information may be transmitted directly between registrant 101 and end-user 113 via network 111. For example, when registrar 103 passes an identification such as, for example, an IP address to an end-user device as information associated with a registered location, the end-user device may use the identification to directly communicate with a website of registrant 101.

In one embodiment, control application 107 may support one or more interfaces 115. One or more interfaces 115 may include one or more graphical user interfaces. One or more interfaces 115 may include a registration interface that enables registrant 101 to set up an account with and register locations with registrar 103. One or more interfaces 115 may also include a location management interface that enables registrant 101 to manage registered locations, associate information with registered locations, upload associated information to registrar 103, or perform other features or functions of the invention. One or more interfaces 115 may also include an end-user interface that enables end-users to interact with registrar 103, and which may enable communication of information associated with registered locations to end-users 113.

One or more interfaces 115 may also include a client module download interface that enables an end-user 113 to download client module 117 or other modules to an end-user device. Other interfaces may also be used. By way of example, registrar 103 may include a web server and one or more interfaces 115 may comprise one or more websites or other graphical user interfaces.

In one embodiment, control application 107 may support one or more data communication interfaces 119. One or more data communication interfaces 119 may include interfaces with different types of hardware and/or software for different types of communications media and protocols to translate information into a format that is compatible with registrar 103, control application 107, one or more modules 109a-109n, and/or other elements of registrar 103. One or more data communication interfaces 119 may also include interfaces that translate data/information received from registrar 103 to a type and/or format that may be transmitted to an end-user device and/or a registrant 101 via network 111 and various communication links.

Those having skill in the art will appreciate that the invention described herein may work with various system configurations. Accordingly, more or less of the aforementioned system components may be used and/or combined in various embodiments. In some embodiments, as would be appreciated, the functionalities described herein may be implemented in various combinations of hardware and/or firmware, in addition to, or instead of, software. In addition, registrar 103 may be implemented as a central registrar or a distributed registrar. For example, in one embodiment, registrar 103 may be integrally formed as a single unit or entity such as, for example, a server or mainframe. In another embodiment, registrar 103 may be implemented separately as two or more devices (for example, a bank of servers and/or storage devices) including a distributed network of devices (a their associated communications infrastructure). In addition, in one embodiment, registrar 103 may be implemented at one geographical location. In another embodiment, registrar 103 may be geographically distributed and connected various communications links.

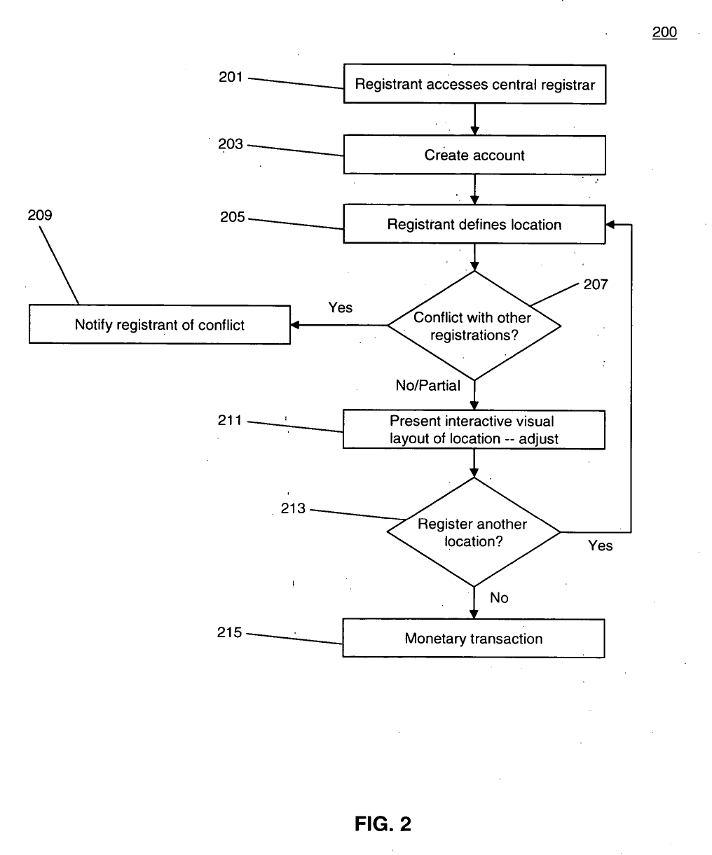

FIG. 1B and FIG. 2 illustrate one example of a process 200 according to various embodiments of the invention, wherein a geospatial location may be registered to registrar 103 by a registrant 101. In an operation 201, registrant 101 may access registrar 103. In one embodiment, this access may be enabled by a registration interface (e.g., one of one or more interfaces 115) supported by registrar 103. In one embodiment, the registration interface may include a website that the registrar accesses using a web browser and a web address(e.g., IP address, URL). Other graphical user interfaces may be used.

In an operation 203, an account may be created with registrar 103 for registrant 101. For example, the registration interface may prompt registrant 101 to enter certain identifying information, billing information, demographic information, or other information. Registrant 101 may then enter this information, which may be stored in database 105 and used to create an account for registrant 101. Registrant 101 may be provided with an identification (e.g., a username) and/or secured access (e.g., a password) that can be used to access the registrant's account and/or for other access to registrar 103.

In an operation 205, registrant 101 may define a geospatial location that registrant 101 wishes to associate with information. For example, in one embodiment, registrant 101 may provide latitudinal, longitudinal, and/or elevation coordinates, GPS coordinates, or other coordinate data that specifies the positions that define the geospatial location registrant wishes to register with registrar 103. In another example, registrant 101 may define the geospatial location using geodata such as, for example, a postal address (e.g., one or more building numbers or lot numbers, street(s), city, county, country, province, zip-code or other postal code, and/or other address information). Registrant 101 may utilize postal address information in conjunction with other information such as, for example, an area measurement (e.g., 2 mile radius surrounding address X), or other information, to define a geospatial location.

In some embodiments, registrant 101 may utilize-third party tools such as, for example, Geographic Information Systems (GIS) (e.g., Google Earth™, Mapquest™) or other tools to retrieve geospatial or geographic data defining the location. In one embodiment, the registration interface may enable registrant 101 to use these third party tools to define the geospatial location. For example, in one embodiment, the registration interface may present an interactive map to registrant 101, who may then define the geospatial location using various navigation tools associated with the interactive map (e.g., pan north, south, east, west; zoom in/out; drawing tools that are, for example, used to draw a box around, or otherwise define, the area to be registered). Any tool that enables registrant 101 to select a position, line, area, or volume may be used to define the geospatial location. In another example, geocoding may be used to define coordinate data for the geospatial location from geodata such as, for example, a street address, input from a GIS, or other geodata,

The measurement system or other methodology described above that registrant 101 uses to define the location may provide “raw position data” of the one or more positions that define the location registrant 101 desires to register. In some embodiments, regardless of how registrant 101 initially defines the geospatial location registrant 101 desires to register, registrar 103 may translate/convert the raw position data of the positions making up the defined geospatial location into one or more positions in a predefined measurement system. This conversion to a predefined measurement system may be used to ensure that all of the locations registered with registrar 103 are ultimately stored in a common measurement system, regardless of how they are initially defined by registrant 101. In some embodiments, there may be no conversion process, and the registrant may only be enabled to initially define the geospatial location he or she wishes to register using raw position data as dictated by the predefined measurement system.

In one embodiment, the predefined measurement system includes a predefined grid of all areas on the planet serviced by the registry. Any defined positions, lines, areas, and/or volumes are then translated into one or more squares on the grid. In one embodiment, the planetary mass (e.g., the Earth) is broken up into the predefined grid. In one embodiment, the predefined grid may comprise a series of 1×1 meter squares for a total of X squares that can be registered. Other square sizes may be used. In some embodiments, shapes other than squares may be used. As the grid approaches the north and south poles, the squares or other shapes used may become irregular (e.g., squares will begin to resemble trapezoids due to map projections (and an n-sided polygon may exist at each of the poles). Regardless of the irregularities caused by the map projections, the shapes of the grid will remain as close to their uniform area as possible (e.g., in the previous example, the 1×1 meter squares will remain as close to 1×1 meter as possible). As mentioned, in some embodiments, non-square areas may be defined (e.g., circles, triangles, octagons, or other shapes) as well as volumes and elevationally-defined areas (e.g., a multiple-story building may have separate registerable locations for each floor).

Once registrant 101 has defined the geospatial location he or she wishes to register, registrar 103 may then search database 105 in an operation 207, to ensure that the defined geospatial location is available for registration. For example, database 105 may store previously registered geospatial locations. In operation 207, registrar 103 checks to make sure there are no conflicts between the registration sought by registrant 101 and geospatial locations already registered in registrar (by registrant 101 or other registrants). In some embodiments, a conflict may occur when more than one registration is attempted for the same (or overlapping) geospatial locations (i.e., each geospatial location on earth may only be registered by one registrant).

In other embodiments, however, a single geospatial location (or one that overlaps other registered locations) may be registered by multiple registrants (or may be registered multiple times to different sets of information) as long as the registrations are for non-conflicting purposes. For example, a state or local government may register an entire town with registrar 103. This registration may associate the entire town with certain historical information, civic information, government services, or other information or services. A business owner whose business is located within the town limits of the same town may then also register his or her place of business with registrar 103. The information associated with the business owner's registration may include a description of the business, may offer services associated with the business, or other information that may be used to categorize the business and/or for the purposes of determining conflicts between registrants or potential registrants. Because the business is located within the previously registered town limits, there will be at least two registrations in registrar 103 for the geospatial location comprising the business owner's place of business. However, because the information associated with each registration is for a different purpose (or at least a non-conflicting purpose), there may be no conflict within the system and the later registering party may be allowed to register their location.

In embodiments where a single location may be registered more than once, multiple registrations may not be allowed for the same purpose or for conflicting purposes. For example, a first business owner may have registered a particular location for business purposes. A second business owner may then attempt to register the same (or overlapping) location for the same or similar purposes (or otherwise conflicting purposes). In this instance, there is a conflict, and the second business owner may be prevented from registering the location. The rules/criteria that determine what constitutes a conflicting purpose may be predefined and may be stored in database 105 and accessed by registrar 103 when conflict searches are performed.

If, in operation 207, the geospatial location defined by registrant 101 is found to conflict with another registration in registrar 103, registrant 101 may be so notified in an operation 209. In some instances, part, but not all, of a geospatial location defined by registrant 101 may be found to conflict with the geospatial location defined by registrant 101. In these instances, registrant 101 may be informed of the partial conflict and may be enabled to register the non-conflicting portion via process 200 and/or proceed with registration of a different geospatial location.

If no conflicts (or partial conflicts that do not dissuade registrant 100 from continuing with partial registration) are found in operation in 207, process 200 proceeds to an operation 211, wherein the area or volume of the geospatial location being registered is computed and the registration interface presents registrant 101 with an interactive visual layout of the area to be registered. In some embodiments, registrant 101 may then interact with various points/positions on this visual layout that precisely define area/volume of the geospatial location to be registered. This interaction by registrant 101 may include moving the points on the interactive visual layout to more precisely define the area/volume of the geospatial location to be registered. For example, in one embodiment, registrant may initially define the geospatial location to be registered by inputting a street address of a building. Registrar 103 may then display to registrant 101 (via registration interface) an interactive layout defining the known location of the building. If, for example, registrant also owns the lot next door to the building, but this lot does not have a street address associated with it, yet registrant wants to register the building and the lot as one location, registrant may interact with the interactive layout to include the lot in the area defining the location to be registered. The area/volume of the location to be registered is then re-calculated. In some embodiments, and updated check for conflicting registrations may be performed. In other embodiments, this precision adjustment operation may take place before any initial search for conflicting registrations is conducted.

In an operation 213, registrant 101 may indicate whether he or she wishes to register another location. If registrant 101 does desire to register another location, the defined geospatial location may be added to registrant 101's account and process 200 may proceed back to operation 205.

If, in operation 213, registrant does not want to register another location, process 200 proceeds to an operation 215, wherein a monetary transaction related to registration of the defined locations may take place. The monetary transaction may include the registrant paying or agreeing to pay a fee to an owner or operator of registrar 103 for registering the defined locations. In some embodiments, registrant 101 may enter billing/payment information (e.g. debit/credit card or payment service information) into registration interface. This billing/payment information is then used by registrar 103 to charge registrant 101 for the registered locations. In other embodiments, registrant 101's billing/payment information may be stored with registrant 101's account information and operation 215 may include registrant 101 indicating agreement to pay for the defined locations.

In one embodiment, the amount charged to registrant for registering a defined location may be based on one or more factors such as, for example, a function of the total area or volume of the defined geospatial location, a function of the population in or around the defined geospatial location, a function of the amount or category of information registrant is registering to the defined geospatial location, a function of the amount or type of services provided in association with the defined geospatial location, a function of the length of time the registrant wishes to register the defined geospatial location, and/or other factors. As some of this information may be as of yet undefined (e.g., the type of information to be associated with the location), registrant 101 may agree to criteria for payment calculation in operation 215. Actual calculation and payment may then take place at another time. In some embodiments, the amount charged to registrant 101 for registering a single defined geospatial location may be a predetermined flat charge.

While the registration interface and process 200 described above is discussed in terms of a web-enabled interface, other interfaces/methods of registration may be utilized. For example, registrant 101 may interact with registrar 103 via paper-based account setup and registration forms and may communicate with registrar via traditional mail, facsimile, automated and/or live call/bill pay service, or other methods.

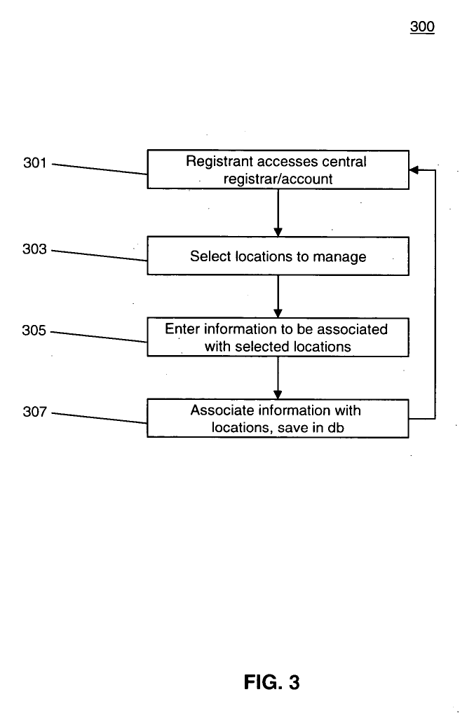

FIG. 1B and FIG. 3 illustrate an example of a process 300 according to various embodiments of the invention, wherein information may be associated with one or more geospatial locations registered in registrar 103. In an operation 301, a registrant 101 who has geospatial locations registered with registrar 103 may access registrar 103. In some embodiments, this access may be enabled by a location management interface, which may be one of the one or more interfaces 115 provided by registrar 103. In one embodiment, location management interface may include a website that registrant 101 accesses using a browser and a specific address (e.g., IP address, URL). Because registrant 101 is attempting to access geospatial locations associated with his or her account, registrant 101 may be prompted by the location management interface to enter in his or her username and/or password to login to and access his or her account. In some embodiments, registrant may enter the location management interface via a link on the registration interface after completing part or all of process 200.

In an operation 303, registrant 101 selects one or more of the geospatial locations associated with his or her account to manage. In an operation 305, registrant 101 then enters information and/or content to be associated with the selected geospatial locations (i.e., the “data set”). In one embodiment, the information and/or content to be registered/associated with the selected locations may include textual information (e.g., text files), one or more media (e.g., audio and/or video files, etc.), multimedia information, software applications, animations, scripts, plugins, other types of data (including metadata), one or more URLs or IP addresses, and/or other information.

The data set provided by registrant 101 may be provided by simply entering the information into a prompt provided by the location management interface. If, for example, the information to be registered with the location were a URL or IP address, the end-user may enter the information onto a prompt provided by the location management interface. In other embodiments, the location management interface may enable registrant 101 to transmit any desired content such as, for example, text, media, multimedia, or other data file types to registrar 103. For example, the location management interface may enable registrant 101 to “browse” a local storage device or otherwise specify a path to the one or more files on the registrant's local computer system and upload a copy of those files to registrar 103. In an operation 307, the data set (information/content) provided by registrant 101 may be associated with the selected registered locations and saved in database 105. The information/content provided by registrant 101 may be provided to, accessed by, or otherwise made available to end-users 113a-113n according to the methods described below.

As registrant 101 may select multiple locations in operation 303, multiple locations may be associated with the same set of information. In some embodiments, a single registered location may be sectioned into two or more sub-locations, each of which is associated with a different or overlapping data set. For example, if registrant 101 operated a department store and registered the entire store as a single geographic location, registrant 101 may then section the store into sub-locations corresponding to the various departments therein. Each department may be associated with a different or overlapping set of information that, for example, communicates the type of merchandise sold in a respective department, or other unique information. In some embodiments, because the sub-locations are all part of a single registered location, the information associated with each sub-location may include a standard set of ubiquitous information in addition to the department-specific information. The foregoing is exemplary only. One having ordinary skill in the art would recognize that other types registrants may register and subdivide other types of locations or provide no overlap or connection between data sets for different locations.

In one embodiment, after the provided information/content is associated/registered with the selected locations and saved in database 105 in operation 307, process 300 may return to operation 303 wherein registrant 101 may associate a different set of information with one or more other locations.

In some embodiments, registrant 101 may be able to access database 105 for the purpose of searching, browsing, and/or viewing registered locations and information associated therewith. In some embodiments, registrant 101 may only search/view locations and associated information registered by registrant 101 (e.g., may only view information related to their account). In other embodiments, registrant 101 may search/view locations and/or associated information registered to other registrants. In some embodiments, a registrant may search, browse, view information related to end-user interaction with registrar 103. This access may be limited to end-user interaction with registrant 101's registered locations or may include the locations of other registrants.

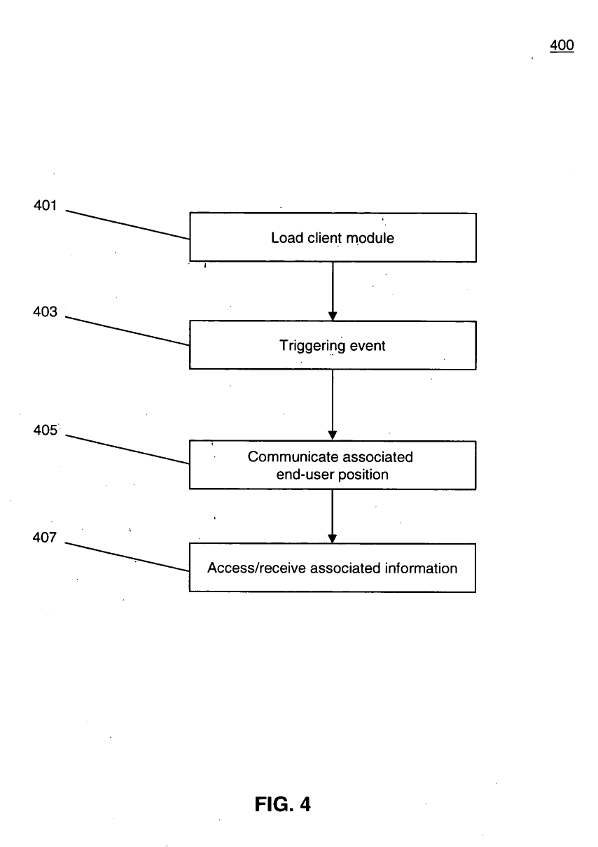

FIG. 1C and FIG. 4 illustrate an example of a process 400 according to various embodiments of the invention, wherein an end-user 113 may access and/or receive information, content and/or, services associated with one or more locations registered with registrar 103. In an operation 401, an end-user 113 may load client module 117 onto their end-user device. In one embodiment, loading client module 117 onto an end-user device may include end-user 113 connecting the end-user device to registrar 103 via network 111 (e.g., the internet) and downloading client module 117 onto the end-user device. In some embodiments, a client module download interface (e.g., a website) may facilitate the download of client module 113 to an end-user device. The client module download interface may be one of the interfaces 115 supported by registrar 103. In other embodiments, client module 117 may be loaded onto a disk (e.g., CD, floppy disk, etc.) and loaded onto the end-user device via the disk. In still other embodiments, client module 117 may be pre-installed onto an end-user device prior to purchase or acquisition by end-user 113. Client module 117 may be loaded onto the end-user device via other methods. In some embodiments, client module 117 operating on an end-user device may be updated, supplemented, augmented, and/or cooperate with additional software operating on the end-user device or downloaded from network 111.

In an operation 403, a triggering event may occur that initiates end-user device access to and/or reception of data from registrar 103. Each triggering event may be associated with an “end-user position” that is used to determine which information registered with registrar 103 is provided to an end-user. There may be multiple types of end-user positions. For example, one type of end-user position may include the “actual position” of end-user 113. In these embodiments, the current or actual position of end-user 113 (e.g., as determined by a GPS enabled end-user device) is considered the “end-user position” and is associated with the triggering event. An example of a triggering event wherein the actual position of end-user 113 is used as an end-user position may include an instance wherein end-user 113 and his or her corresponding end-user device enter or come within a specified distance of a geospatial location registered with registrar 103. Approaching or entering the registered location triggers client module 117 residing on the end-user device to access and/or receive information from registrar 103.

Another type of end-user position data may include a “position of interest.” In these embodiments, the actual position of end-user 113 or the end-user device is not considered the end-user position and is not associated with the triggering event. In these embodiments, a position that end-user 113 has explicitly or implicitly indicated an interest in is considered the “end-user position” and is associated with the triggering event. Examples of a triggering event wherein a position of interest is considered an end-user position may include end-user 113 typing the name of a place located within a registered location into a search engine (explicit indication of interest) or visiting a website of an event held at a place within a registered geospatial location (implicit indication of interest). Client module 117 residing on the end-user device transmits these explicit or implicit indications of interest to the registrar, which triggers access to information stored on the registrar.

Triggering events may also be based on the fulfillment of certain conditions. For example, end-user 113 may specify one or more preferences as to when to receive information (i.e., part or all of a data set) associated with a registered location. These preferences may define one or more conditions that must be met for end-user 113 to receive associated information. In one instance, an end-user 113 may specify that he or she wants to receive information associated with a registered location only when his or her end-user device comes within a registered location. In another instance, end-user 113 may specify that he or she is to receive information associated with a registered location when their end-user device is within one mile of a registered location (essentially expanding the area covered by the registered position for the purposes of that end-user). Other preferences may be used that set different conditions for different locations or types of locations, that set time/date parameters for triggering events, or that specify other conditions. In some embodiments, environments, environmental conditions, usage data, historical trends, bio-feedback information (e.g., temperature monitor on end-user 113 triggers info to end-user 113 regarding hot beverage vendor), telepathic input, cerebral activity, ocular movement (e.g., for end-users 113 who have medical conditions such that ocular movement is only method of communication), voice data, individual or collective emotion, or other information may be used to set conditions for triggering events and/or may be collected as end-user metrics by registrar 103.

In one embodiment, client module 117 residing on end-user device may store and/or manage the conditions/parameters used for triggering events. In other embodiments, one or more modules 109a-109n of control application 107, database 105, or other portion of registrar 103 may enable storage/management of conditions/parameters used in triggering events. In one embodiment, end-users 113 may establish accounts with registrar 103 and their profile/preferences and/or any personal or identifying information may be stored on database 105 of registrar 103. In one embodiment, client module 117 may manage the collection of the above-mentioned end-user parameters/data and the transmission of the collected parameters/data to registrar 103.

In one embodiment, the end-user device may maintain a persistent or near persistent connection with registrar 103 (e.g., similar to a wireless email device's connection to a wireless email server). In one embodiment, the end-user device may continuously send end-user position data to registrar 103. In another embodiment, the end-user device may send end-user position data to registrar 103 periodically or at a predetermined interval. In one embodiment, when the end-user position sent to registrar 103 is not within a location registered with registrar 103, registrar 103 may respond to the end-user device with a message that indicates that no information is available for the current end-user position. In another embodiment, when the end-user position sent to registrar 103 is not within a location registered with registrar 103, registrar 103 may send no response.

In one embodiment, when the end-user position sent to registrar 103 is within a location registered with registrar 103, registrar 103 may send (or the end-user device may retrieve) part or all of the information/content associated with the registered location to the end-user device.

As mentioned above, the preferences of end-users 113 may be used to filter information sent to end-user devices. As such, when the end-user position sent to registrar 103 is within a location registered with registrar 103, the information/content associated with the location is only sent to the end-user device if end-user 113's preferences allow the information to be sent. For example, an end-user 113 may approach a gas station operated by Company X which is registered with registrar 103. However, end-user 113's preferences may specify that end-user 113 only wishes to receive information/content related to gas-stations operated by Company Y. As such, the information/content associated with the registered location (the gas station owned by Company X) is not sent to the end-User device.

In another example, if an end-user 113 has a favorite coffee shop, the end-user may mark the location of the favorite coffee shop in the end-user's preferences and be sent information relating to the coffee shop by the end-user device whenever end-user 113 enters or comes within a specified distance from that specific coffee shop.

In embodiments where a persistent or near-persistent connection is maintained between an end-user device and registrar 103, a triggering event may be considered an instance wherein the end-user device sends an end-user position to registrar 103 that is within a location registered with registrar 103. In some embodiments, a triggering event may be considered the end-user device sending an end-user position to registrar 103 that is within a location registered with registrar 103 and that meets end-user 113's preferences. Other events that initiate or form part of a causal chain of events leading to transmission of information associated with a registered location from registrar 103 to an end-user device may also be considered triggering events.

In an operation 405, the end-user position associated with the triggering event is communicated to registrar 103. In some embodiments, such as those wherein a persistent or near-persistent connection is maintained between the end-user device and registrar 101, communication of an end-user position within a registered location may itself comprise the triggering event (e.g., operation 403 and 405 may be coincidental). In other embodiments, triggering event may occur, and the end-user position associated with the triggering event may be communicated to registrar 103 thereafter.

In some embodiments, such as those wherein a persistent or near-persistent connection between the end-user device and registrar 103 is not maintained, the end-user device may connect to registrar 103 via network 111 (e.g., the internet, a wireless network, a combination thereof, or other network) to communicate the end-user position to registrar 103.

In some embodiments, operation 405 may include a query, which searches registrar 103 to determine whether the end-user position corresponds to (e.g., is a position within the boundaries of, or within a specified distance from) a registered geospatial location. In other embodiments, client module 117 may not communicate with registrar 103 unless client module 117 knows that the end-user position associated with the triggering event corresponds to a geospatial location presently registered with registrar 103 (e.g., the triggering event does not trigger any action unless the end-user position is a position within the bounds of, or within a specified distance from, a registered geospatial location). In these embodiments, client module 117 informs registrar 103 of the end-user position associated with the triggering event.

In an operation 407, client module 117 accesses and/or receives information/content associated with the corresponding geospatial location stored in database 105.

In one embodiment, multiple triggering events may be involved in ultimate access of certain information/content associated with a location. For example, an end-user 113 and his or her corresponding end-user device may access/receive information/content associated with a first registered location (e.g., a shopping mall) and a plurality of registered sub-locations (e.g., individual stores within the mall) existing within the larger location. As end-user 113 enters or approaches the first registered location (e.g., a first triggering event), the end-user device may communicate an end-user position to registrar 101, which recognizes that the end-user position is within (or within a specified distance from) the first registered location (the shopping mall). Information related to the first location in general (e.g., a list of stores within the mall, location of parking, etc.) may be sent to the end-user device, along with the specific location boundaries of each of the sub-locations within the first registered location (e.g., the stores within the mall). When end-user 113 enters or comes within a specified distance of one of the registered sub-locations (a second triggering event), the end-user device may access/receive specific information/content associated with the sub-location.

As discussed above, the end-user device may maintain a persistent or near-persistent connection with registrant through which the information regarding the first location (the shopping mall) and the information regarding the sub-locations (the individual stores) may be sent. In other embodiments, the end-user device may receive information from registrar 103 regarding the first location and remain offline from registrar 103 until the user approaches one of the stores (e.g., the second triggering event), whereupon the end-user device re-connects with registrar 103, sends an end-user location corresponding to one of the individual stores, and receives information related to the specific store.

In one example of process 400, client module 117 may be loaded onto an end-user device that is a GPS-enabled automobile navigation system in an end-user 113's automobile (operation 401). In this example, a state park may comprise one of the geospatial locations registered with registrar 103. As end-user 113's automobile enters or comes within a specified distance of the state park (triggering event of operation 403), client module 117 connects (automatically or in response to user action) to registrar 103 via network 111 (alternatively, a persistent connection is maintained with registrar 103 and connection is unnecessary). In this example, network 111 may include a local wireless network (such as, for example, that which is used for mobile phones) in conjunction with the Internet.

Client module 117 then transmits the end-user 113's position (which, for example, may include GPS coordinates of the end-user device) to registrar 103 via network 111. Because the end-user 113's position is within a registered geospatial location (e.g., the park) client module 117 is provided with information in registrar 103's database 105 associated with the state park.

In this example, the information associated with/registered to the one or more locations may comprise an IP address. As such, registrar 103 may act similar to a domain name server (DNS), which provides an IP address of a website in response to a user providing a URL. Registrar 103 provides an IP address for the state park's website in response to the end-user position rather than a URL (operation 411). The end-user device may then launch a browser and connect to the state park's website using the IP address sent from registrar 103. In other embodiments, wherein the information associated with/registered to the one or more locations is a URL or domain name, registrar 103 provides the end-user device with the URL or domain name in response to the end-user device providing registrar 103 with an end-user position. The end-user device must then provide a DNS server (not illustrated) with the URL or domain name in exchange for an IP address.

In other embodiments, the information associated with the state park may not be an IP address or a URL but may include one or more text files, video files, audio files, and/or other file, media, or content containing information regarding the state park. In these embodiments, the one or more files, media, or other content may be sent to the end-user device in operation 411, whereupon client module 117 or other software modules facilitate communication of the information contained in the transmitted files, media, or content (e.g., displaying any text to end-user 113, playing any audio or video files to end-user 113).

Other examples of the use of the methods and systems provided herein include, use by commercial organizations or groups thereof acting as registrants 101 to establish “virtual storefronts” via the presentation of information related to their brick and mortar store locations to end-users 113.

In one embodiment, the invention may enable “GPS realty services” or. “virtual doormats” that enable realtors, property owners, or other entities to register and market properties for sale or rental. For example, prospective home buyers or others interested in buying real estate may automatically receive information related to a prospective home (or other property) when they arrive at the property. In other embodiments, information related to a property that is for sale may be displayed not only to prospective home buyers, but to passers-by, based on their proximity to the property. In some embodiments, the virtual doormat may be used to present a video and/or audio guided tour of the property on a handheld end-user device (e.g., such as, during an open house). In other embodiments, end-user devices may present a “virtual tour” to prospective buyers or other end-users.

Yet another example of potential uses for the invention include travel-related services. In one embodiment, rest-stops, gas stations, hotels, restaurants, and/or other businesses may push advertisements (and/or provide location and travel time information) to end-users traveling in automobiles (e.g., to GPS-enabled car navigation systems) before the end-users reach the aforementioned businesses. For example, highway travelers may be sent coupons in advance for restaurants at the next rest stop. In another example, travelers entering airport grounds may be directed to their to their gate, may be notified that their plane is on-time or delayed, and/or may be provided with other information.

In one embodiment, historical locations, museums, landmarks, parks, monuments, battlefields, governmental organizations, tour services, or other areas of interest may also push information to travelers via the systems and methods of the invention. In one embodiment, guided tours of these types of sites that are viewable/playable on an end-user device may be enabled by the invention.

In one embodiment, the invention may enable the use of special kiosks that act as end-user devices and provide specific information based on their specific position and the areas of interest surrounding it. When moved/repositioned, a kiosk may download updated content pertinent to its new position. For example, kiosks in a museum can be moved to provide extra consoles for special events. In another example, kiosks could be moved from an old exhibit to a new one. The kiosk references the registrar to check what information should be available/displayed at its new location, thus eliminating the need for a technician to install a new program.

Another example includes use of the invention for emergency services. For example, government or public services may push emergency information to some or all end-user devices in certain areas or based on other criteria. For example, Amber Alerts maybe pushed to end-user devices in proximity to an abduction location (in addition to TV, radio, and stationary road signs). In other embodiments, elderly persons or those with serious medical conditions may leave beacons that pinpoint their location to family, emergency medical technicians, police, hospitals, or other emergency services.

In one instance, the invention may push advertisements to users based on their position (e.g., as indicated by a GPS-enabled mobile end-user device), biofeedback, preferences, or other factors. For example, while end-users shop at a shopping mall, advertisements for the stores the end-users pass may be displayed on a mobile end-user device. Further, if an end-user has a preference that specifies interest in “shirts on sale,” only ads for those stores currently having a sale on shirts will be displayed on the end-user device.

In one instance, the invention enables a “brick and mortar” facility to provide a viewable webpage when an end-user is in the proximity of the facility. For example, when an end-user pulls into the parking lot of a department store, that store may push an icon to the end-user's end-user device that displays a list of current sales and the hours of operation. In another example, a restaurant may push an icon to the end-user device which displays the average wait time, any daily specials, enables the end-user to place their name on a waiting list, notifies the end-user when their table is ready, and/or performs other functions.

In another instance, the invention provides a service that may guide an end-user around a store to purchase items of interest and advertise particular items when the end-user is in proximity to those items. For example, an end-user may search (using their end-user device) for a list of grocery items. Their end-user device may then display a map indicating the shortest path to those items. Additionally, when the end-user is approaching an item on their list, advertisements for the product they were searching for (or competitors' products) may be displayed, showing comparable sales, unit prices, and/or other information.

In one embodiment, the invention may enable workers to store information relating to a particular repair job or other event. For example, road workers can document the last time a particular stretch of roadway was surfaced, record the locations of potholes so that crews can return to repair them, and/or store other information.

In one embodiment, the invention may enable sports-related information to be available to participants or spectators at a sporting event. For example, sports-data related to previous games/contests, player statistics, and or other data may be provided to spectators while attending a sporting event (e.g., football, baseball, basketball, or other sporting events). In some embodiments, maps, and/or other data related to a golf course may be provided to a golfer during a round at the golf course.

In one embodiment, information related to other forms of recreation may be provided using the invention. For example, a fisherman may, after discovering a particularly bountiful fishing location, may “save” that location using his or her end-user device (e.g., a GPS-enabled device may mark the location) so that the fisherman can more easily re-locate the same position. In other embodiments, teenagers or other groups of people looking to establish a “digital spatial hangout” may mark a location and/or leave a secret message at a particular location as a marker for others in the group.

In one embodiment, an administrator or other entity may delineate the information available at particular times for any service enabled by the invention. For example, a user outside a restaurant at 9:00 a.m. can request a breakfast coupon versus a lunch or dinner coupon.

In some embodiments, the invention may provide training or educational services. Training typically takes place in advance of or during a time period where an individual requires the training. However, rarely does training take place at the time needed to implement the knowledge. Furthermore, the training is not automatically provided to the person in need of the knowledge. The invention may solve these problems, for example, by recognizing where an end-user is located, what activity the end-user is engaged in, and/or other circumstances, and providing “just in time” or “last minute” training to end-users. The training may include, for example, information, tutorials, or stored knowledge based on what is known to be located at the end-user's current position and consequently what the end-user might be working on. This enhances the end-user's ability to perform a task.

As described above, a registrant 101 may register multiple locations to a common set of information. For example, an owner of a chain of stores may wish to register each store in the chain to a website for the stores. In registering multiple locations to a common set of information, a registrant 101 may provide raw position information to registrar 103 regarding the multiple locations registrant 101 wishes to register. The store owner of the above example may provide raw position information (e.g., latitude and longitude coordinates) that defines the area or volume of each store the owner wishes to register. Alternatively, registrar 103 may gather the raw position information using, for example, an address provided by registrant 101. This raw position information may be gathered by the GIS tools discussed above (e.g., Mapquest™, Google Earth™, or other tools), may be derived from a postal address or other geocodes, may be obtained by physically sending a surveyor or other person to each location (e.g., each store in the chain) to measure the actual physical positions defining each location, or may be otherwise obtained.

The raw position information for the positions defining each of the locations may then be used to determine the locations desired to be registered by registrant 101. For example, the store owner may provide the raw position information to registrar 103, which may utilize the raw position information to derive sets of one or more positions defining a location desired for registration. Alternatively, registrant 101 may derive the sets of one or more positions defining a location desired for registration from the raw position information and provide the sets of positions to registrar 103. As registrant 101 desires to register multiple locations to a common set of information in this embodiment, the registrant may provide raw position information or sets of positions defining a plurality of locations. These locations may then be registered with registrar 103, as described herein (including, for example, checking for conflicting registrations, charging a fee, storing the defined locations in database 105, or other operations).

As described above, registrant 101 may associate a common set of information to the plurality of registered locations. In the store owner example, the store owner may desire to associate a common website with all of the stores in the chain so that the same website is displayed on an end-user device when an end-user approaches any of the stores in the chain. As such, the store owner may provide the web address, domain name, IP address, or other identifier for the website to registrar 103. This identifier is the common set of information that is to be associated with the multiple locations. Registrar 103 may then associate the web address, domain name, IP address, or other identifier with the multiple locations in registrar 103's database 105 using the systems and methods described above (e.g., process 300). As such, wherever end-user position data is received at registrar 103 that falls within, or within a specified distance from, the boundaries defined by the positions of any of the registered locations, the common set of information will be transmitted to or otherwise made available to the end-user device.

For example, when an end-user enters or approaches one of the stores in the chain of stores registered by the store owner, the end-user's end-user device will send an end-user position to registrar 103 that is within (within a specified distance from) the boundaries defined for each store in the chain. Registrar 103 then sends the web address, domain name, IP address, or other identifier for the store website to the end-user device, thus enabling the end-user device to access the store website.

In some embodiments, in addition to having a common set of information (e.g., web address) associated with a plurality of locations, each individual location within the plurality of locations may also be associated with a distinct set of information. For example, each store in the chain of stores described above may be associated with an identifier (e.g., web address, domain name, IP address) to a website or webpage that provides unique information or services related to that store (e.g., directions, specials, enables ordering of items from the store, etc.). This unique website or web page may be in addition to the common website associated with all the stores in the chain. In some embodiments, the unique website or webpage may used instead of the common website, rather than in addition to it. The unique set of information may be associated with an individual location within a plurality using the processes described herein (e.g., process 300). In some embodiments, the “unique” set of information need not necessarily be unique to a single location, but may be common to two or more locations within the plurality of locations, so long as not common to all.

The aforementioned potential uses of the invention are exemplary only. Those having skill in the art will recognize that other uses and applications of the invention may also exist.

In one embodiment, all interaction or data exchanged with registrar 103 may be logged and stored in database 105 (or other database), including interaction between registrants 101 and registrar and end-users 113 and registrar. This data may be stored in the individual accounts or profiles of registrants 101 and end-users 113 and/or may be stored in a separate log that tracks usage and interaction.

In one embodiment, the data stored in database 105 of registrar 103 (e.g., the registered geospatial locations and associated information) may be associated with one or more data characteristics such as, for example, address-based characteristics (e.g., hemisphere, country, region, state, province, city, county, street number or other address-based characteristics), land-type characteristics (e.g., mountainous region, desert, coastline, or other land-type characteristics), use-related characteristics (e.g., parkland, resort, commercial district, residential, population, or other use-related characteristics), business-related characteristics (e.g., type of business located at location, business name, ownership, or other business-related characteristics), registrant-related characteristics (e.g., what registrants have registered a specific location, for what purpose has the registrant registered, or other registrant-related characteristics), the type of information associated with a registered location (e.g., a URL, text, files, video files, audio files, or other information-related characteristics), and/or other characteristics.

In one embodiment, the invention provides one or more data services to end-users 113. The one or more data services may include enabling an end-user 113 to search, browse, and otherwise view registered locations and associated information contained within database 105 of registrar 103. In one embodiment, a user 113 may be able to search, browse, or filter the registered locations and associated information based on one or more characteristics of the data (e.g., the characteristics listed above or other characteristics).

While the invention has been described with reference to the certain illustrated embodiments, the words that have been used herein are words of description, rather than words of limitation. Changes may be made, within the purview of the associated claims, without departing from the scope and spirit of the invention in its aspects. For example, one skilled in the art will appreciate that various operations of the processes described above may be omitted and/or rearranged or performed in a different order. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the associated claims.

What is claimed is:

1. A computer-implemented method for associating a set of information to a geospatial location and for providing the associated information to an end-user via an end-user device, the method comprising:
receiving a defined geospatial location from a registrant;
receiving a data set from the registrant, wherein the data set includes data related to the defined geospatial location;
storing the defined geospatial location and the data set in a database, wherein the data set is accessed based on the defined geographic location;
receiving an end-user position from an end-user device;
determining whether the end-user position is within the defined geospatial location; and
transmitting at least part of the data set to the end-user device when the end-user position is within the defined geospatial location.

2. The method of claim 1, wherein the end-user position is considered within the defined geospatial location when the end-user position is within a predetermined distance from the defined geospatial location.

3. The method of claim 1, wherein the defined geospatial location is defined using a measurement system that includes one or more of longitude, latitude, and elevation coordinates.

4. The method of claim 1, wherein associating the defined geospatial location with the data set further comprises computing a fee for storing the defined geospatial location in the central registration database and associating the defined geospatial location with the data set.

5. The method of claim 4, wherein the fee is based on one or more of the total area comprising the defined geospatial location, the total volume comprising the defined geospatial location, the size of the data set, and the type of data comprising the data set.

6. The method of claim 1, wherein the data set comprises one of a uniform resource locator (URL) or an IP address.

7. The method of claim 6, wherein sending at least part of the data set to the end-user device further comprises displaying a website whose address is the URL or the IP address, the website being related to the defined geospatial location.

8. The method of claim 1, wherein the data set comprises one or more of one or more text files, one or more audio files, and one or more video files.

9. The method of claim 1, wherein the end-user position comprises an actual position of the end-user.

10. The method of claim 1, wherein the end-user position includes a position of interest of the end-user.

11. A system for associating information to a geospatial location and for providing the associated information an end-user via an end-user device, the system comprising:
a registration database to store existing defined geospatial locations and associated data; and
a registrar to receive a defined geospatial location from a registrant, to determine whether the received defined geospatial location may be registered in the registration database based on the existing defined geospatial locations, to receive a fee for registering the received defined geospatial location in the registration database, and to store the received defined geospatial location in the registration database, thereby registering the received defined geospatial location.

12. A method for associating information to a geospatial location and for providing the associated information an end-user via an end-user device, the method comprising:
storing existing defined geospatial locations and associated data in a registration database;
receiving a defined geospatial location from a registrant;
determining whether the received defined geospatial location is registerable in the registration database based on the existing defined geospatial locations;
receiving a fee for registering the received defined geospatial location in the registration database; and
storing the received defined geospatial location in the registration database, thereby registering the received defined geospatial location.

13. A method for providing information about an entity to an end-user based on a plurality of locations associated with the entity, the method comprising:
receiving first raw position information pertaining to at least one first position associated with the entity;
determining a first location of the plurality of locations associated with the entity from said at least one first position based on said first raw position information;
receiving second raw position information pertaining to at least one second position associated with the entity;
determining a second location of the plurality of locations associated with the entity from said at least one second position based on said second raw position information;
associating, in a data storage system, said first location and said second location with a web address of the entity;
receiving an end-user user position associated with the end-user; and
providing said web address of the entity to the end-user when said end-user position is within either said first location or said second location.

14. The method of claim 13, wherein said receiving an end-user position comprises receiving an end-user position from the end-user via an end-user device.

15. The method of claim 13, wherein said receiving an end-user position comprises receiving an end-user position from an end-user device that provides a measurement of its position.

16. The method of claim 13, wherein receiving first raw position information comprises receiving raw first position information that was gathered by measuring a plurality of physical positions at said first location.

17. The method of claim 13, wherein receiving second raw position information comprises receiving second raw position information that was gathered by measuring a plurality of physical positions at said second location.

18. The method of claim 13, wherein receiving first raw position information comprises receiving an address of said first location.

19. The method of claim 13, wherein receiving second raw position information comprises receiving an address of said second location.

20. The method of claim 13, further comprising:
associating, in said data storage system, said first location with a second web address associated with said first location; and
providing said second web address to the end-user when said end-user position is within said first location.

21. The method of claim 13, further comprising:
associating, in said data storage system, said second location with a third web address associated with said second locations; and providing said third web address to the end-user when said end-user position is within said second location.
